(19) United States
(12) Patent Application Publication
(10) Pub. No.: US 2025/0370159 A1
(43) Pub. Date: Dec. 4, 2025

(54) Foldable Airborne Carrier Device for Magnetic Geosurveys

(71) Applicant: UMag Solutions ApS, Birkerød (DK)

(72) Inventors: Arne Døssing Andreasen, Vaerlose (DK); Eduardo Lima Simoes Da Silva, Kobenhavn NV (DK); Mick Emil Kolster, Naerum (DK)

(21) Appl. No.: 18/877,694

(22) PCT Filed: Jun. 24, 2022
(86) PCT No.: PCT/EP2022/067379

§ 371 Date: Dec. 20, 2024

(51) Int. Cl. G01V 3/165; B64D 3/00

(52) U.S. Cl. CPC G01V 3/165; B64D 3/00

(57) ABSTRACT

An airborne sensor carrier device for magnetic geosurveys. The airborne sensor carrier device is configured to be towed by an aircraft in an upright operating position. The airborne sensor carrier device comprises a frame, which is elongated in a longitudinal direction. In the upright operating position, the longitudinal direction corresponds to the vertical direction. The airborne sensor carrier device further comprises an anchor assembly, which is configured for attachment of one or more towlines to the airborne sensor carrier device. Further, the airborne sensor carrier device comprises one or more sensor holders, which are connected to the frame and configured for attachment of a magnetic sensor. In order to be handled more easily, the frame is configured to be collapsible from the operating position to a transport configuration, where a length of the airborne sensor carrier device along the longitudinal direction is shorter than in the operating position.

The invention relates to an airborne sensor carrier device for magnetic geosurveys, the device being configured to be towed by an aircraft in an upright operating position.

Airborne sensor carrier devices of this type are known and used to survey the soil and subsurface for exposed and hidden objects, such as buildings and archaeology, as well as munitions, buried ordnance, and other contamination. The survey is usually performed using magnetic sensors, because the objects in the soil induce changes to the Earth's magnetic field, which allow their detection. In some applications, a gradient of the magnetic field is measured, which necessitates the use of two or more sensors, which are spaced apart from one another at a fixed distance.

Depending on the particular application and the required measurement resolution, the optimal distance between the magnetic sensors varies from one application to another. Moreover, the relative position of the sensors needs to be accurately known in order to determine the gradient exactly.

It is an object of the invention to provide an airborne sensor carrier device for magnetic geosurveys that is easy to handle, while still providing data of the highest possible quality.

This object is solved in that the airborne sensor carrier device comprises a frame which is elongated in a longitudinal direction, the longitudinal direction corresponding, in the upright operating position, to the vertical direction; an anchor assembly, the anchor assembly being connected to the frame and being configured for attachment of one or more towlines to the airborne sensor carrier device; and one or more sensors holders, each of the one or more sensor holders being connected to the frame and configured for an attachment of a sensor; wherein the frame is configured to be collapsible from the operating position to a transport configuration, a length of the device along the longitudinal direction being short in the transport configuration that in the operating position.

This solution facilitates transport of the airborne sensor carrier device due to the reduced length in the transport configuration.

The above solution may be improved by each of the following features. The following features are independent of one another and can be arbitrarily combined, depending on whether the technical effect associated with a feature is beneficial or even necessary for a particular application.

In one embodiment, the airborne sensor carrier device may be configured to also be towed in a horizontal operating position, in which the longitudinal direction corresponds to the horizontal direction or the flight direction, respectively. This adds to a more versatile applicability of the airborne sensor carrier device.

In the upright operating position, the longitudinal axis is, in particular, perpendicular to the flight direction which corresponds to a fore-aft direction. The flight direction determines the yaw, pitch and roll direction as is conventional. The vertical direction is the direction which is aligned with the direction of gravity.

The aircraft that is used to tow the airborne sensor carrier device may be one of a helicopter, drone, airplane, zeppelin and/or balloon. At least one towline may connect the airborne sensor carrier to the aircraft.

The frame is preferably made from non-magnetic material, so that the measurements by the sensors is not influenced by the frame.

The frame may be collapsible by being telescopic. For example, the frame may comprise two or more rods, where at least one rod can be moved into at least one other rod.

However, a folding joint assembly is preferred over a telescopic arrangement. In a telescoping frame, special care must be given to cables that run within the telescoping rods, which is not necessary in the case of rotating joints.

Thus, the airborne sensor carrier device may comprise at least one folding joint assembly for collapsing the device from the operating position to the transport configuration. The folding joint assembly is preferably located between at least one of the one or more sensor holders and the anchor assembly. A folding axis, i.e. an axis of rotation of the at least one folding joint assembly may be perpendicular to the longitudinal direction. In particular, the folding joint assembly may be located at a mid-point of the frame in the longitudinal direction. Thus, the two folded halves are of the same length, which results in the greatest reduction length in the transport configuration.

If more than one folding joint assembly is used, the airborne sensor carrier device may be collapsed into even smaller segments. The two or more folding joint assemblies may in this case be spaced apart from one another, preferably equidistantly, in the longitudinal direction. If, for example, two folding joint assemblies are provided, the airborne sensor carrier device may be folded at two locations, i.e. three folding segments are provided. The three folding segments preferably are of the same length.

According to another embodiment, the airborne sensor carrier device may comprise a sensor yaw angle adjustment joint, which is configured for yaw-angle adjustment of at least one of the one or more sensor holders. The yaw angle adjustment joint allows a precise alignment of the sensors used in the airborne sensor carrier device. Moreover, if the yaw-angle is adjusted appropriately, the airborne sensor carrier device can be used without re-configuration in both a flight direction and a reverse direction. Thus, the maneuverability of drones can be exploited. The yaw angle adjustment joint may also be provided on an airborne sensor carrier device which is not collapsible.

The sensor yaw angle adjustment joint may be located between the anchor assembly and the at least one or more sensor holders. Thus, the orientation of the anchor assembly is not altered, when the yaw angle of the at least one sensor holder is adjusted.

The yaw axis, i.e. the axis of rotation of the sensor yaw angle adjustment joint is parallel to the longitudinal direction.

The folding joint assembly may be located in one embodiment between the sensor yaw angle adjustment joint and the anchor assembly. This helps in maintaining structural integrity and thus stability of the part of a frame which is rotated when the yaw angle is adjusted.

The sensor yaw angle adjustment joint may connect an upper part of the frame rotatably to a lower part of the frame. The upper part may comprise the anchor assembly, whereas the lower part may comprise at least one, preferably all, sensor holders.

The anchor assembly may comprise a towline fixation member, such as a clamp or a hook, which is configured to be fastened to at least one towline and/or which allows to fasten the at least one towline to the airborne sensor carrier device, in particular the frame. The towline fixation member is preferably arranged at the center of gravity or, alternatively, at the aerodynamic center of the airborne sensor carrier device. The aerodynamic center is preferably determined at an airspeed at which the airborne sensor carrier device is predominantly used. If the airborne sensor carrier device is used at different airspeeds, the towline fixation member may be located between two aerodynamic centers which are determined at two different operational airspeeds. As the location of the towline fixation member determines where the towing force is introduced into the airborne sensor carrier device, its location at the center of gravity or at an aerodynamic center ensures that the upright operating position is stable during flight.

According to a further embodiment which does not require that the frame is collapsible, at least one of the one or more sensor holders may comprise a sensor pitch angle adjustment joint and sensor mount, wherein the sensor pitch angle adjustment joint is located between the sensor mount and the frame. The sensor mount is configured for attachment of a sensor. For example, the sensor mount may be or may comprise a clamping ring, which is clamped around the sensor, or a cage-like receptacle, in which the sensor may be received.

The sensor pitch angle adjustment joint allows to adjust the pitch angle of the sensor. The sensor pitch angle adjustment joint connects the sensor mount to the frame rotatably around a pitch axis, i.e. an axis of rotation which is perpendicular to the longitudinal direction. The pitch axis is perpendicular to the yaw axis.

For different types of geosurveys, e.g. different requirements with respect to resolution and distance above ground, it is advantageous if at least one of the one or more sensor holders and/or the frame is configured to be fixed to the frame in at least two different positions along the longitudinal direction. For example, the at least one sensor holder may be fixed at two different positions on one or more rods of the frame. For this, the sensor holder may comprise a clamping device which can be released for changing the position and be fastened for fixing the position along the frame during flight.

In one embodiment, the frame may comprise at least two parallel rods, where at least one of the one or more sensor holders, preferably all sensor holders, is connected to the at least two parallel rods. For example, the at least one sensor holder may be arranged between the rods. The rods may extend in the longitudinal direction of the airborne sensor carrier device.

Especially if fiber-reinforced rods, such as carbon-fiber enforced rods are used, this leads to a very lightweight airborne sensor carrier device. The rods may be hollow to receive cables for energy supply and/or data transmission.

The parallel rods may be connected to one another at discrete locations by crosslinks to increase stability. The crosslinks can, for example, be provided by the sensor yaw angle adjustment joint and/or a sensor holder.

The airborne sensor carrier device may comprise one or more device holders, which are preferably located above the anchor assembly, in particular above the towline fixation member. There may be one or more device holders, e.g. one device holder for holding a battery, one or more device holders for holding a controller and/or or more device holders for holding supporting equipment such as an inertial measurement unit, a geolocation sensor and/or radio link hardware. More than one device may be arranged along a circumferential direction around the frame, i.e. around the longitudinal direction.

The device holders and the devices held by the device holders are preferably arranged within a housing. This allows the devices to be sheltered from the environment. Further, the housing may have an aerodynamic shape to reduce drag.

The at least one battery may be used to supply energy to all electric devices that are mounted onto the airborne sensor carrier device. The one or more inertial measurement units may provide information about the movement of the airborne sensor carrier device. The controller may collect data from the sensor and transmit them wirelessly or wired to another device, such as a ground station or a receiver in the aircraft, thereby using e.g. the radio link hardware. The controller may further be adapted to determine the position and movement parameters of the airborne sensor carrier device during operation by receiving signals from a global navigation satellite system. All these devices may be part of the airborne sensor carrier device. The radio link hardware may be configured for wireless data transmission, which may be unidirectional or bidirectional, between the airborne sensor carrier device on one side and the aircraft and/or a ground station on the other.

As any of the above-described devices impacts the measurement of the magnetic sensors, they, or their device holders, are preferably arranged on the airborne sensor carrier device as remotely as possibly from the magnetic sensors or the sensors holders, respectively. In particular, the device holders may be arranged at an upper end of the frame or the airborne sensor carrier device, i.e. the end that is closest to the aircraft during operation in the upright position.

In another embodiment, the airborne sensor carrier device may comprise a crossbar assembly, which extends perpendicular to the longitudinal direction, in particular along a lateral direction which is perpendicular to the fore-aft direction. The crossbar assembly may be used for supporting one or more device holders. For example, the device holders for the inertial measurement units may be arranged at the crossbar assembly.

Using a crossbar assembly allows to pack more of these devices together that disturb the magnetic field and thus may impact the quality of measurement of the sensors in the sensor holders.

Preferably, the crossbar assembly is arranged at an upper end of the frame. The anchor assembly may be arranged between the crossbar and the folding joint.

The crossbar assembly may extend from both sides of the frame so that at each side of the frame, a device holder may be arranged on the crossbar assembly. The crossbar assembly may be covered by the housing mentioned above.

The crossbar assembly may comprise one or more rods that extend perpendicular to the frame, in particular along a lateral direction, i.e. from starboard to port with respect to the flight direction.

The provision of the crossbar assembly is independent of the collapsibility of the frame. The crossbar assembly may also be provided in an airborne sensor carrier device that is not collapsible.

In order to prevent uncontrolled rolling and yawing motions, a towline arrangement as described in WO 2018/028956 A1, which is incorporated in its entirety by reference, may be used. Thus, two towlines that are laterally spaced apart from one another may be brought together at the anchor assembly.

The crossbar assembly may comprise a towline guide assembly which, in particular, may be configured to keep two towlines laterally spaced apart from one another. In this configuration, the crossbar assembly is not only used for receiving peripheral devices, but also for guiding the towlines and for securing the upright operating position.

To keep the towlines laterally spaced apart from one another, the towline guide assembly may comprise, in an embodiment, two or more towlines guides that are arranged on two opposing ends of the cross bar. Thus, a triangle is formed of which one side is formed by the crossbar assembly and the other two sides are formed by two towlines, which converge onto the anchor assembly, where the towlines are fastened to the frame. Each towline is assigned to and held by a different towline guide. The twoline guides are optional features that can be mounted as separate units onto the crossbar.

The towlines may, in one embodiment, be fastened to the towline guides. It is, however, preferred that the towlines are received slidingly at least along the length direction of the towlines in the respective towline guide. According to the most preferred embodiment, however, each towline guide is configured to guide a towline along a predetermined path in the fore-aft direction. Thus, the towline may slide in the fore-aft direction relative to and at the crossbar while being fixed to the frame by the anchor assembly. This arrangement helps in maintaining the upright operating position during various flight speeds, as a forward shift of the towline allows to compensate for increased drag without inducing a pitch of the sensor carrier device.

In a particularly advantageous embodiment, each of the guiding elements comprises a slot that extends perpendicularly to the longitudinal direction. Each slot is dimensioned to receive the cross-section of the towline slidingly, both in the length direction of the towline and in the fore-aft direction.

Each slot extends preferably in the fore-aft direction. Preferably, all slots are arranged in the same plane or, equivalently, at the same height with respect to the longitudinal direction.

Once the towlines have moved forward along the towline guides at a higher velocity, it would be beneficial if the towlines slide back automatically when the velocity is reduced. This may be achieved according to one embodiment, in that a distance between the slots of the guiding elements increases along the fore-aft direction in a direction away from the frame. This increase may take place at only one side of the frame, but preferably takes place at both sides. Thus, the slots may be symmetrical in the fore-aft direction and mirror-symmetrical with respect to each other. As the weight of the sensor carrier device strives to draw the towlines together, this configuration will automatically move the towlines to a position where the towing force is balanced by the weight. If there is only a small towing force, i.e. a small flight velocity, the two towlines will automatically slide to a position where the distance between them is smallest.

Preferably, the distance between the two slots is smallest where the slots are closest to the frame. The slots may be straight, so that each towline guide is V-shaped. Alternatively, the two slots may be curved so that each towline guide is U-shaped. The apex of the V and U, i.e. the location where the distance between the two slots is smallest, is preferably located at the frame.

The airborne sensor carrier device may further comprise an antenna mount which is mounted on the frame, preferably at the upper end of the frame. The antenna mount may be configured for attachment of the antenna and may comprise an antenna fold-up joint for pivoting the antenna between the operating position and the transport position. In the operating position, the antenna preferably extends along the longitudinal direction. In the transport configuration, the antenna is preferably folded away.

The antenna may be used for receiving signals from a global navigation satellite system and/or for receiving and transmitting data.

In the following, an exemplary embodiment is described with reference to the drawings. In the drawings, elements which correspond to one another with respect to function and/or structure, are given the same reference numeral.

The combination of features that is shown in the embodiment can be changed as described above. For example, a feature of the embodiment below can be omitted if its technical effect is not required for a particular application. Vice versa, a feature which is described above but not comprised in the embodiment below, may be added if the technical effect of this feature is beneficial, or required for a particular application.

In the figures,

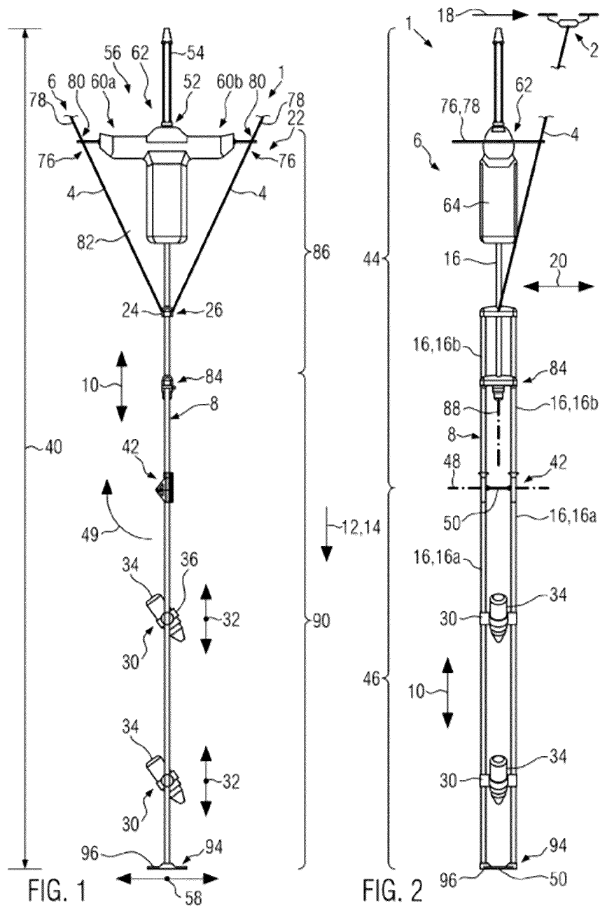

FIG. 1 shows a schematic front view of an example of an airborne sensor carrier device for magnetic geosurveys;

FIG. 2 shows a schematic side view of the airborne sensor carrier device of FIG. 1;

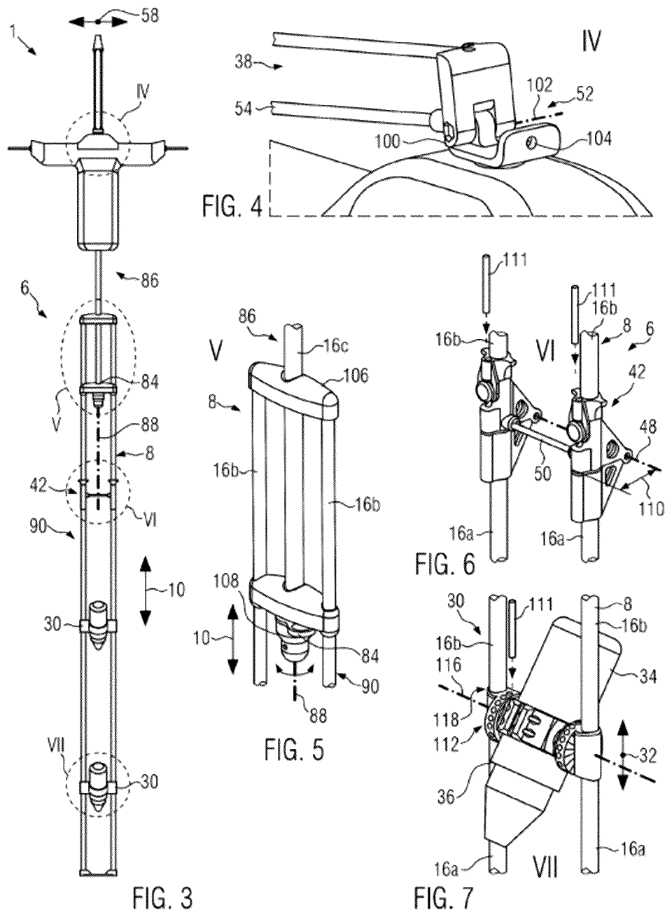

FIG. 3 shows a schematic front view of the airborne sensor carrier device of FIG. 1 in a different operational set up;

FIG. 4 shows a schematic perspective view of a detail IV of the airborne sensor carrier device of FIG. 3;

FIG. 5 shows a schematic perspective view of a detail V of the airborne sensor carrier device of FIG. 3;

FIG. 6 shows a schematic perspective view of a detail VI of the airborne sensor carrier device of FIG. 3;

FIG. 7 shows a schematic perspective view of a detail VII of the airborne sensor carrier device of FIG. 3;

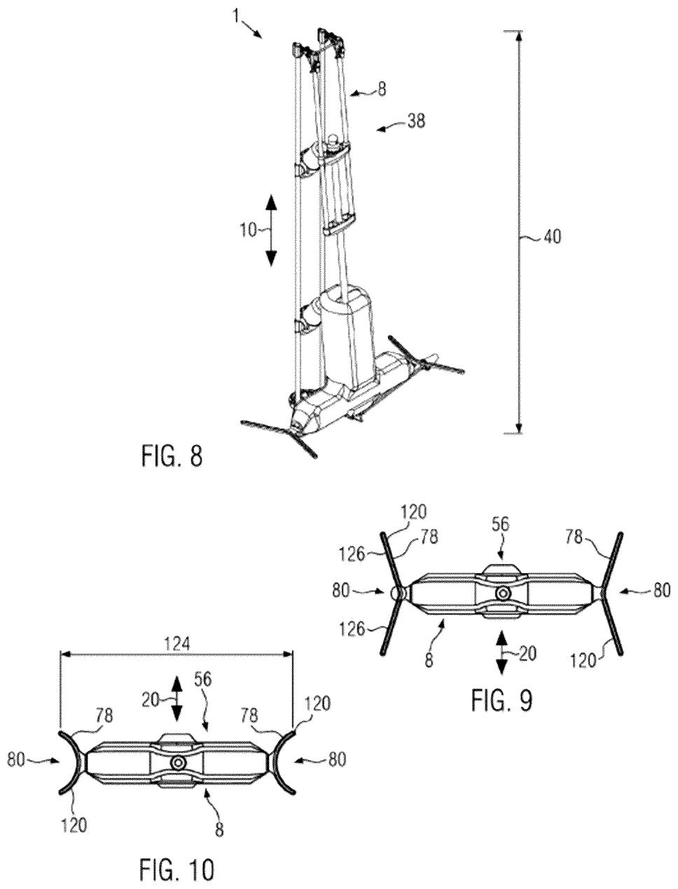

FIG. 8 shows a schematic perspective of the airborne sensor carrier device of FIGS. 1 to 3 in a transport configuration;

FIG. 9 shows a schematic top view of an embodiment of the airborne sensor carrier device of FIGS. 1 to 3;

FIG. 10 shows a schematic top view of another embodiment of the airborne sensor carrier device of FIGS. 1 to 3;

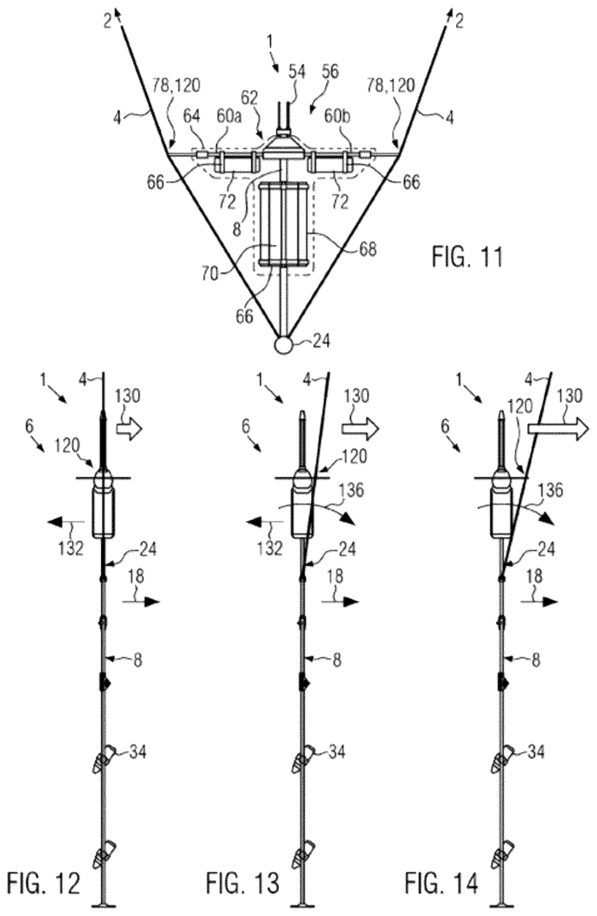

FIG. 11 shows a schematic front view of part of an airborne sensor carrier device without a housing and with towlines; and

FIGS. 12 to 14 show a schematic side view of an airborne sensor carrier device at different towing velocities.

First, the structure of an airborne sensor carrier device 1 is described with reference to FIGS. 1 and 2.

The airborne sensor carrier device 1 as shown is primarily configured to be used in magnetic geosurveys. More specifically, the airborne sensor carrier device 1 is configured to be towed by an aircraft 2, which may be a helicopter, a drone, an airplane, a zeppelin or a balloon. For towing, the airborne sensor carrier device 1 is connected to the aircraft by at least one towline 4. An exemplary towline configuration for use with the airborne sensor carrier device 1 is disclosed in WO 2018/028956 A1 which is herewith incorporated by reference in its entirety.

The airborne sensor carrier device 1 is configured to be towed by the aircraft 2 in an upright operating position 6 shown in FIGS. 1 and 2.

The airborne sensor carrier device 1 comprises a frame 8, which is preferably made from nonmagnetic material. The frame 8 is elongated in a longitudinal direction 10.

In the upright operating position 6, the longitudinal direction 10 is parallel to the vertical direction 12, i.e. the direction which is aligned with the direction of gravity 14.

The frame 8 may comprise a plurality of rods 16, which may all extend along the longitudinal direction 10. The rods 16 may be made from a resin material, in particular a fiber-reinforced rod.

For example, the rods 16 may be carbon rods, i.e. rods which are reinforced with carbon fibers. Crosslinks may be provided which connect at least some rods to one another to add structural stability an integrity.

In operation, the aircraft 2 and thus the airborne sensor carrier device 1 towed by the aircraft 2 move in a direction of flight 18, which is perpendicular to the vertical direction 12. The direction of flight 18 corresponds to a fore-aft direction 20 of the airborne sensor carrier device 1.

As is conventional, the direction of flight 18 or the fore-aft direction 20, respectively, determines the directions of pitch, yaw and roll.

The airborne sensor carrier device 1 further comprises an anchor assembly 22, which is configured for the attachment of the at least one towline 4. A location of attachment 24 of the at least one towline 4 is preferably located at the center of gravity of the airborne sensor carrier device 1. Alternatively, the location 24 may be located at the aerodynamic center, where the aerodynamic center is determined by a predetermined operational speed of flight. The expression “located at a location” also includes a position close to this location. The predetermined operational speed of flight may correspond to a speed of flight at which the airborne sensor carrier device 1 is towed through the air in the majority of survey applications.

In an alternative embodiment, the location 24 may be located between the center of gravity and the aerodynamic center. Arranging the location of attachment at any of these positions facilitates that the airborne sensor carrier device 1 maintains its upright position in operation.

To attach the at least one towline 4, the anchor assembly 22 may comprise a towline fixation member 26, which may comprise one or more hooks or clamps (not shown) which are configured to fix the at least one towline 4 to the airborne sensor carrier device 1. The towline fixation member 26 is positioned at the location of attachment 24 and is connected to or directly mounted on the frame 8.

The airborne sensor carrier device 1 may comprise one or more sensor holders 30, which are connected to or directly mounted on the frame 8. As exemplarily shown in the embodiment of FIGS. 1 and 2, the frame 8 may comprise two or more parallel rods 16 in the area where the one or more sensor holders 30 are arranged. The one or more sensor holders 30 may be arranged between two parallel rods 16 and be connected or directly mounted to each of the parallel rods 16. In particular, each sensor holder 30 may be shifted in a displacement direction 32 along the frame 8. The displacement direction 32 is parallel to the longitudinal direction 10. The displacement of the sensor holder 32 allows to adjust the distance between two or more sensors 34 in the vertical direction 12 (i.e. the longitudinal direction 10) for the different applications.

If there is a plurality of sensor holders 30, the different sensor holders 30 of the plurality are arranged spaced apart from one another in the longitudinal direction 10.

Each sensor holder 30 is configured for attachment of a sensor 34. For this, the sensor holder 30 may provide a sensor receptacle 36, in which a sensor 34 or, if required, more than one sensor 34, may be received.

In order to facilitate transport of the airborne sensor carrier device 1, the frame 8 is configured to be collapsible from the operating position 6, as shown in FIGS. 1 and 2, to a transport configuration 38, which is shown in FIG. 8. In the transport configuration 38, a length 40 of the airborne sensor carrier device 1 in the longitudinal direction 10 is smaller in the transport configuration 38 than in the operating position 6, as can be seen from a comparison of FIGS. 1, 2 and 8.

The airborne sensor carrier device 1 as shown in FIGS. 1 and 2 may have a length 40 between 1.5 m and 4 m in the operating position 6. It is towed approximately 4 to 10 m below the aircraft 2. In the transport configuration 38, the length 40 may be slightly larger than half the length 40 in the operating position 6.

To collapse the airborne sensor carrier device 1 in the transport configuration 38, a telescoping arrangement can be provided, where some rods 16a (cf. FIG. 2) slide into hollow rods 16b. Alternatively, the rods 16a may of course be hollow to receive the rods 16b within.

However, it is preferred that the airborne sensor carrier device 1 comprises at least one folding joint assembly 42, which allows to fold an upper part 44 of the airborne sensor carrier device 1 relative to a lower part 46 of the airborne sensor carrier device 1. The expressions “upper” part and “lower” part refer to the operating position 6 and the gravity direction 14 in the operating position 6. To collapse the airborne sensor carrier device 1, the folding joint assembly 42 may have an axis of rotation 48, which is perpendicular to the longitudinal direction 10. The folding axis 48 around which the folding joint assembly 42 pivots may, in the operating position 6, be oriented horizontally. The folding motion of the lower part 46 relative to the upper part 44, is shown at reference numeral 49 in FIG. 1.

If two or more folding joint assemblies 42 are provided, the individual folding joint assemblies 42 are spaced apart from one another in the longitudinal direction 10. The segments of the airborne sensor carrier device 1 that can be folded relative to each other around the folding joint assemblies 42 are preferably of the same length.

The folding joint assembly 42 may be located at the midpoint of the frame 8 in the longitudinal direction 10, i.e. the upper part 44 of the frame 8 may approximately have the same length as the lower part 46 of the frame 8.

The folding joint assembly 42 may be arranged in an area of the frame 8 where two parallel rods 16 are provided. The folding joint assembly 42 may comprise a bracket member 50 or a crosslink which connects the two rods 16 and adds stability in this area, not only in the transport configuration 38, but also in the operating position 6 where airflow-induced vibrations in the frame 8 should be minimized. Alternatively or additionally, the folding joint assembly 42 may be arranged between at least one sensor holder 30 and the anchor assembly 22.

The folding joint assembly 42, the sensor holder 30 and/or the anchor assembly 22 are preferably made from non-magnetic material in order to avoid any distortion of the magnetic which may influence the measurements of the at least one sensor 34. For example, any of these components may be made from a mesh material.

According to a variant of the embodiment shown in FIGS. 1 and 2, there may be more than one folding joint assembly 42, so that the frame 8 can be collapsed to an even smaller transport configuration 38. For example, there may be two folding joint assemblies 42 spaced apart from each other in the longitudinal direction, so that the frame 8 may be collapsed into three parts.

The airborne sensor carrier device 1 may further comprise an antenna mount 52, which is configured for attachment of an antenna 54 for a global navigation satellite system and/or an antenna 54 for wireless data transmission. The antenna 54 may of course be used for both receiving signals from a global navigation satellite system, and sending and/or receiving data, such as survey data.

As shown, the antenna 54 may extend along the longitudinal direction 10 in the operating position 6.

The airborne sensor carrier device 1 may further comprise a crossbar assembly 56 which extends perpendicularly to the longitudinal direction 10 and preferably also in a direction perpendicular to the fore-aft direction 20, i.e. extend along a lateral direction 58.

The crossbar assembly 56 may comprise two arms 60a, 60b, which extend from opposite sides of the frame 8. The crossbar assembly 56 may be arranged at an upper end 62 of the frame 8. Additionally or alternatively, the anchor assembly 22 may be arranged between the crossbar assembly 56 and the folding joint assembly 42. Alternatively or additionally, the location of attachment 24 of the at least one towline 4 may be located halfway between the crossbar assembly 56 and the folding joint assembly 42.

A housing 64, especially an aerodynamic housing, may be provided in which the crossbar assembly 56 is received. FIGS. 1 and 2 show the crossbar assembly 56 with the housing 64. In FIG. 11, an example of the interior of the housing 64 is shown.

As can be seen, a device holder 66 may be connected or directly mounted onto the frame 8 close to the upper end 62. The device holder 66 may, for instance, be a cage-like shape and be configured for attachment of one or more batteries 68 and/or a controller 70.

Further, the crossbar assembly 56 may also comprise one or more device holders 66 of the same or a different configuration than the device holder 66 on the frame 8. In the embodiment shown in FIG. 11, each arm 60a, 60b of the crossbar assembly 56 comprises a device holder 66, which is configured for attaching supporting equipment 72, such as sensors and electronics, o the crossbar assembly 56. The supporting equipment 72 that may be accommodated by the device holder 66 may for example comprise an inertial measurement unit, a geolocation sensor and/or a radio link hardware. Each arm 60a, 60b may house a different device.

Preferably, all device holders 56 as well as any device attached thereto are preferably arranged within the housing 64.

As the antenna 54, the supporting equipment 72, the battery 68 and the controller 70 may all affect magnetic measurements by the sensors 34, they are arranged as remotely as possible from the sensors 34. Thus, in order to minimize the influence of these devices, they are arranged at the upper end 62.

Returning to FIGS. 1 and 2, the airborne sensor carrier device 1 may comprise a towline guide assembly 76. The towline guide assembly 76 is configured to guide the at least one towline 4 along a predetermined path relative to the frame 8, when the airborne sensor carrier device 1 is being towed.

In the embodiment of FIGS. 1 and 2, where, for example, two towlines 4 may be used, two towline guides 78 are used that are spaced apart from one another in the lateral direction 58. Each guide 78 is preferably assigned to a different towline.

The towline guide assembly 76, with its optional towline guides 78, may be arranged between the anchor assembly 22 and the aircraft 2, preferably at the upper end 62 of the frame 8.

As an example only, the guides 78 can be provided at opposite lateral ends 80 of the crossbar assembly 56. Thus, a triangle 82 is formed between the anchor assembly 22 and the towline guide assembly 76, which stabilizes the airborne sensor carrier device 1 in the upright operating position 6 and prevents pitching, yawing and rolling motions during flight.

The airborne sensor carrier device 1 may further comprise a sensor yaw angle adjustment joint 84 which is configured for yaw-angle adjustment of at least one of the one or more sensor holders 30. The sensor yaw angle adjustment joint 84 connects a first part 86 of the frame 8 rotatably about a yaw axis 88 to a second part 90 of the frame 8. The yaw axis 88 extends parallel to the longitudinal direction 10. In particular, the yaw axis 88 may lie in a plane about which the airborne sensor carrier device 1 is mirror symmetrical.

The first part 86 preferably comprises the crossbar assembly 56, the anchor assembly 22 and the towline guide assembly 76. The second part 90 may primarily comprise the sensor holders 30.

The sensor yaw angle adjustment joint 84 may be located between the anchor assembly 22 and at least one sensor holder 34. The sensor yaw angle adjustment joint 84 may in particular be located between the anchor assembly 22 and the folding joint assembly 42.

FIG. 3 shows the airborne sensor carrier device 1 in an operating position 6, where the second part 90 of the frame 8 is rotated by 90° about the yaw axis 88 compared to FIGS. 1 and 2. Of course, the sensor yaw angle adjustment joint 84 allows for a rotation by other angles about the yaw axis as well.

In the configuration shown in FIG. 1, the sensor holders 30 are arranged a yaw angle that allows the sensors 34 to be used without repositioning when the aircraft reverses flight direction, of which a drone is capable without any problems.

A lower end 94 of the airborne sensor carrier device 1 may be formed by the frame 8. The lower end 94 is opposite the upper end 62 in the longitudinal direction and may comprise a grounding protector 96. The grounding protector 96 is configured to protect the frame 8 and the airborne sensor carrier device 1 upon ground contact of the lower end 94.

Two parallel rods 16a, 16b may essentially extend from the yaw angle adjustment joint 84 to the lower end 94. The grounding protector 96 may connect the two rods 16 by forming a bracket 50 which connects the two rods 16 as a crosslink, as in the case of the folding joint assembly 42.

FIG. 4 shows an example of an antenna mount 52 with the antenna 54. The antenna mount 52 may comprise an antenna folding joint 100, which is arranged between the antenna 54 and the frame 8. An axis of rotation 102 of the antenna folding joint 100 is perpendicular to the longitudinal direction 10 and preferably parallel to the lateral direction 58. A locking means 104, such as a latch, may be provided to lock the antenna folding joint 100 in the operating position 6, which is shown in FIGS. 1 to 3. In FIG. 4, the transport configuration 38 is shown in which the antenna 54 is folded towards the frame 8 by means of the antenna folding joint 100.

FIG. 5 shows an example of a sensor yaw angle adjustment joint 84. The sensor yaw angle adjustment joint 84 may connect a central rod 16c of the first part 86 of the frame 8 to the two parallel rods 16a and 16b of the second part 90 of the frame 8. The central rod 16c preferably extends coaxially to the yaw axis 88 in the longitudinal direction 10. A further bracket 106 may connect the ends of the two parallel rods 16a, 16b rotatably to the central rod 16c, so that the rods 16a, 16b and 16c overlap and are parallel to one another between the bracket 106 and the swivel joint 84. A yaw angle lock 108 may be provided to fix the relative yaw position between the second part 90 and the first part 86 during operation of the airborne sensor carrier device 1.

FIG. 6 shows an example of a folding joint assembly 42. As can be seen, the folding axis 48 may be offset by a distance 110 in the fore-aft direction 20 from the frame 8 or a plane defined by the two parallel rods 16a, 16b. The distance 110 allows to fold the second part 90 of the frame 8 parallel to the first part 86 of the frame 86. Again, a locking means 111 may be provided to lock the folding joint in the operating position 6. For example, the locking means 111 may be inserted into the two parts of the swivel joint 84 which are rotatable with one another, so that the sensor yaw angle adjustment joint 42 is fixated upon insertion.

FIG. 7 shows an example of a sensor holder 30. The sensor holder 30 may comprise a sensor pitch adjustment joint 112, which connects the sensor receptacle 36 pivotably about a pitch axis 116 relative to the frame 8. The sensor receptacle 36 may be a clamping ring or a cage configured for receiving and fixating the sensor 34. As already explained with reference to FIGS. 1 and 2, the sensor holder 30 may be displaceable in a displacement direction 32 along the frame 8, in particular along two parallel rods 16a, 16b.

The sensor pitch adjustment joint 112 may also comprise locking means 118, which are configured to fixate the sensor pitch adjustment joint 112 in any rotating position or in discrete rotating positions. For example, locking bars may be inserted into the sensor pitch angle adjustment joint 112 to lock it at predetermined rotational positions. The locking bars used to fixate the sensor pitch adjustment joint 112 may be the same that are used to fixate the folding joint assembly 42.

FIGS. 9 and 10 show examples of towline guides 78, which are mounted on the opposite lateral ends 80 of the crossbar assembly 56, respectively. Each towline guide 78 comprises a contiguous slot 120, which is dimensioned to receive the cross-section a towline 4 (not shown in FIGS. 9 and 10). Each slot 120 is further dimensioned so that the respective towline 4 may slide along the slot 120 perpendicular to the length extension of the towline 4. In particular, each towline 4 may slide in the fore-aft direction 20 along the respective slot 120. The slot 120 is preferably located in a horizontal plane and extends perpendicular to the longitudinal direction. Each slot 120 extends along the flight direction 18, i.e. in the fore-aft direction 20. However, a distance 124 between the opposing slots 120 increases along the fore-aft direction 20 or, in a direction away from the frame 8. The distance between the two slots 120 is smallest where the slots 120 are closest to the frame 8. The two towline guides 78 are preferably mirror-symmetrical with respect to one another and/or symmetrical in the fore-aft direction 20.

As can be seen in FIG. 9, each slot 120 may have a V-configuration and comprise two straight legs 126 that extend in the fore-aft direction. Alternatively, the slots 120 may be curved and, for example, have a U-shape.

In FIG. 11, the extension of the towlines 4 through the towline guides 78 or the slots 120 is shown. The towlines 4 extend from the location of attachment 24 away from each other in the lateral direction to the towline guides 78 and further to the aircraft 2. This triangular or V-shaped configuration stabilizes the airborne sensor carrier device 1 in flight.

The effect of the slots 120 that diverge from one another symmetrically in the fore-aft direction 20 as shown in FIGS. 9 and 10, is now explained with reference to FIGS. 12, 13 and 14.

FIG. 12 shows the airborne sensor carrier device 1 which is towed at a low flight velocity 130. The flight velocity 130 is low enough that any drag forces 132 exerted by the airflow around the airborne sensor carrier device 1 are small. Due to the weight of the sensor carrier device 1, the two towlines 4 automatically move to a position along the slots 120 where the distance between the slots 120 is minimal. This is because the weight of the airborne sensor carrier device 1 tends to bring the two towlines 4 together.

FIG. 13 shows the airborne sensor carrier device 1 as it is towed with a flight velocity 130 that is larger than the flight velocity 130 in FIG. 12. In order to overcome the increased drag force 132, the towline 4 must exert a larger towing force 134 in the flight direction 18. Thus, the towline 4 will slide in the flight direction 18 along the slots 120 until the position shown in FIG. 13 is reached. In this position, the force created by the weight of the airborne sensor carrier device 1, which tries to bring the two towlines 4 closer to one another and thus move them along the slots to the location shown in FIG. 12, is compensated by the towing force 134.

The towline 4 exerts a towing force not only on the location of attachment 24 of the towlines 4, but also at the slot 120. The force generated at the slots 120 introduces a rightening momentum 136, which increases with increased flight speed. The rightening momentum 136 keeps the operating position 6 of the airborne sensor carrier device 1 upright and compensates for the increased drag acting on the lower half of the frame 8 where the sensors 34 are located.

If the flight speed 130 is further increased, as shown in FIG. 14, the towlines 4 will slide further in the front direction along the slots 120, keeping the upright position of the airborne sensor carrier device 1 in spite of a further increased drag force 132.

If the flight speed 130 is again reduced, the towlines 4 will slide back towards the frame, where they are less widely spaced apart, due to the weight of the airborne sensor carrier device 1.

### REFERENCE NUMERALS

1 airborne sensor carrier device
2 aircraft
4 towline
6 (upright) operating position
8 frame
10 longitudinal direction
12 vertical direction
14 gravity direction
16, 16a, 16b, 16c rods
18 direction of flight
20 fore-aft direction
22 anchor assembly
24 location of attachment of the at least one towline
26 towline fixation member
30 sensor holder
32 displacement direction of sensor holder
34 sensor
36 sensor receptacle
38 transport configuration
40 length of airborne sensor carrier device
42 folding joint assembly
44 upper part of frame
46 lower part of frame
48 folding axis
49 folding motion
50 stabilizing bracket
52 antenna mount
54 antenna
56 crossbar assembly
58 lateral direction
60a, 60b arm
62 upper end of frame
64 housing
66 device holder
68 battery
70 controller
72 supporting equipment
76 towline guide assembly
78 guide
80 lateral ends of crossbar assembly
82 triangle
84 sensor yaw adjustment/swivel joint
86 first part of frame
88 yaw axis
90 second part of frame
94 lower end of frame
96 grounding protector
100 antenna folding joint
102 axis of rotation of antenna folding joint
104 locking means
106 bracket
108 yaw angle lock
110 offset distance
111 locking means
112 sensor pitch adjustment joint
116 pitch axis
118 locking means
120 slot
124 distance between slots
126 leg of slot
130 flight speed
132 drag force
134 towing force
136 rightening momentum

1. An airborne sensor carrier device (1) for magnetic geosurveys, the airborne sensor carrier device (1) being configured to be towed by an aircraft (2) in an upright operating position (6) and comprising:
a frame (8) which is elongated in a longitudinal direction (10), the longitudinal direction (10) corresponding, in the upright operating position (6), to a vertical direction (12),
an anchor assembly (22), the anchor assembly (22) being connected to the frame (8) and being configured for attachment of one or more towlines (4) to the airborne sensor carrier device (1), and
one or more sensor holders (30), each of the one or more sensor holders (30) being connected to the frame (8) and configured for an attachment of a sensor (34);
wherein the frame (8) is configured to be collapsible from the operating position (6) to a transport configuration (38), a length (40) of the device along the longitudinal direction (10) being shorter in the transport configuration than in the operating position (6).

2. The airborne sensor carrier device (1) according to claim 1, wherein the airborne sensor carrier device (1) further comprises
a folding joint assembly (42) for collapsing the device from the operating position to the transport configuration, the folding joint assembly being located between at least one of the one or more sensor holders and the anchor assembly (22), an axis of rotation of the folding joint assembly (42) being perpendicular to the longitudinal direction (10).

3. The airborne sensor carrier device (1) according to claim 1, wherein the airborne sensor carrier device (1) further comprises
a sensor yaw angle adjustment joint (84) configured for yaw-angle adjustment of at least one of the one or more sensor holders (30), the sensor yaw angle adjustment joint (84) being located between the anchor assembly (22) and the at least one of the one or more sensor holders (30), and wherein a yaw axis (88), about which the sensor yaw angle adjustment joint (84) is rotatable, extends parallel to the longitudinal direction (10).

4. The airborne sensor carrier device (1) according to claim 1, wherein at least one of the one or more sensor holders (30) comprises
a sensor pitch angle adjustment joint (112) and a sensor receptacle (36), the sensor receptacle (36) being configured to be attached to a sensor (34);
the sensor pitch angle adjustment joint (112) being located between the sensor receptacle (36) and the frame (8), the sensor pitch angle adjustment joint (112) further connecting the sensor receptacle (36) to the frame (8) rotatably around an axis of rotation which is perpendicular to the longitudinal direction (10) for pitch angle adjustment of the sensor receptacle (36).

5. The airborne sensor carrier device (1) according to claim 1, wherein at least one of the one or more sensor holders (30) is configured to be fixed to the frame (8) in at least two different positions along the longitudinal direction (10).

6. The airborne sensor carrier device (1) according to claim 1, wherein the frame (8) comprises at least two parallel rods (16, 16a, 16b) and wherein at least one of the one or more sensor holders (30) is connected to the at least two parallel rods (16, 16a, 16b).

7. The airborne sensor carrier device (1) according to claim 1, wherein the airborne sensor carrier device (1) comprises a crossbar assembly (56) which extends perpendicular to the longitudinal direction (10).

8. The airborne sensor carrier device (1) according to claim 7, wherein the crossbar assembly (56) extends from both sides of the frame (8).

9. The airborne sensor carrier device (1) according to claim 7, wherein the crossbar assembly (56) comprises a towline guide assembly (76).

10. The airborne sensor carrier device (1) according to claim 9, wherein the towline guide assembly (76) comprises two towline guides (78) that are arranged on two opposing ends of the crossbar assembly.

11. The airborne sensor carrier device (1) according to claim 10, wherein each of the towline guides (78) comprises a slot (120) that extends perpendicular to the longitudinal direction (10).

12. The airborne sensor carrier device (1) according to claim 11, wherein a distance (124) between the slots (124) increases along a fore-aft direction (20) with the distance from the frame (8).

13. The airborne sensor carrier device (1) according to claim 1, wherein the airborne sensor carrier device (1) comprises an antenna mount (52) which is mounted on the frame (8), the antenna mount (52) being configured for attachment of an antenna (54) and comprising an antenna fold-up joint (100) for pivoting the antenna (54) between the operating position (6) and the transport configuration (38).

14. The airborne sensor carrier device (1) according to claim 1, wherein the frame (8) is composed of rods (16) connected by crosslinks (50).

15. The airborne sensor carrier device (1) according to claim 14, wherein one or more sensor holders (30) is arranged slidably between two parallel rods.

16. The airborne sensor carrier device (1) according to claim 1, wherein the frame is made from non-magnetic material.

17. The airborne sensor carrier device (1) according to claim 1, wherein the anchor assembly comprises a towline fixation member which is configured to be fastened to at least one towline, wherein the towline fixation member is located between two aerodynamic centers which are determined at two different operational airspeeds.

18. The airborne sensor carrier device (1) according to claim 3, wherein the sensor yaw angle adjustment joint connects an upper part of the frame rotatably to a lower part of the frame, wherein the upper part comprises the anchor assembly, whereas the lower part comprise at least one of the sensor holders.

19. The airborne sensor carrier device (1) according to claim 3, wherein the folding joint assembly is located between the sensor yaw angle adjustment joint and the anchor assembly.

20. The airborne sensor carrier device (1) according to claim 5, wherein the one or more sensor holders (30) comprise a clamping device which can be released for changing the position and be fastened for fixing the position along the frame during flight.
